(19) United States
(12) Patent Application Publication
(10) Pub. No.: US 2024/0154993 A1
(43) Pub. Date: May 9, 2024

(54) SCALABLE REPORTING SYSTEM FOR SECURITY ANALYTICS

(71) Applicant: CloudBlue LLC, Irvine, CA (US)

(72) Inventors: Evgenni ANDRIUKHIN, Sofia (BG); IIya KOSTYULIN, Badalona (ES); Mikhail BUROV, Sofia (BG)

(21) Appl. No.: 18/493,764

(22) Filed: Oct. 24, 2023

Related U.S. Application Data
(63) Continuation-in-part of application No. 17/980,336, filed on Nov. 3, 2022.

(51) Int. Cl. H04L 9/40; H04L 41/22

(52) U.S. Cl. CPC H04L 63/1433; H04L 41/22; H04L 63/105

(57) ABSTRACT

The disclosure includes systems and methodologies for managing and evaluating the security posture of microservices in software development environments. The system addresses the challenges of fragmented and time-consuming security management processes by providing a unified and automated approach. It includes an abstraction process that transforms and standardizes security data from multiple Application Security tools into a centralized platform. The abstraction process simplifies the complexity of managing security across diverse microservices and enables efficient risk assessment and mitigation strategies. By integrating historical data and leveraging forecasting analysis, the system predicts potential security risks and trends, facilitating proactive vulnerability identification and resolution. The system's automation capabilities reduce manual effort, minimize human error, and streamline the security management workflow. It promotes collaboration among development and security teams, enhances overall security, and contributes to the production of more secure and reliable software products.

### CROSS-REFERENCE TO RELATED APPLICATIONS

This application is a Continuation-in-Part (CIP) of U.S. patent application Ser. No. 17/980,336, filed on Nov. 3, 2022, incorporated herein by reference in its entirety.

### BACKGROUND

The present disclosure relates to the field of software development, specifically to the management and evaluation of microservice security within a software development environment.

In traditional software development environments, managing and evaluating the security posture of microservices has been a fragmented and time-consuming process. Multiple Application Security tools are typically employed to collect and analyze security data, resulting in a lack of a unified and comprehensive view of the security landscape. This fragmentation makes it challenging for development teams to identify and prioritize vulnerabilities effectively, leading to potential security risks.

Moreover, the existing technology often requires manual intervention to collect, analyze, and deduplicate data from various Application Security tools. This manual approach introduces the risk of human error and inconsistencies in evaluating security risks. Furthermore, the lack of an automated method to compare results from different tools makes it difficult to identify overlaps or discrepancies in security assessments.

Additionally, the prior technology has limitations in efficiently utilizing historical data and forecasting analysis, hindering the ability to predict future security risks and trends. This drawback makes it challenging for development teams to anticipate potential vulnerabilities and proactively implement preventive measures. The complexity of managing vulnerabilities across diverse microservices, programming languages, base images, and third-party components adds further complexity and resource consumption to the process.

Overall, the traditional approach to managing and evaluating microservice security suffers from fragmentation, inefficiency, manual effort, inaccurate detection, and limited utilization of historical data. These shortcomings necessitate the development of an innovative and unified system that addresses these challenges and streamlines the process for enhanced security management.

### BRIEF SUMMARY OF THE INVENTION

Embodiments described herein manage and evaluate the security posture of microservices, addressing the limitations of traditional approaches through a comprehensive system. In some embodiments, the system employs an abstraction process to transform and standardize security data from various Application Security tools. For example, it identifies a higher-level view of the security posture of microservices, simplifying the complexity of managing and evaluating security across diverse components and programming languages.

In some embodiments, the abstraction process involves extracting and consolidating security-related data from multiple Application Security tools. For instance, it integrates this data into a unified and standardized format within a centralized platform, providing a comprehensive understanding of the security landscape and eliminating the need to manually navigate through various tools and datasets.

In some embodiments, the transformed and standardized security data supports automation and integration with existing development tools and processes. This allows for efficient data collection, analysis, and reporting, reducing reliance on manual efforts and minimizing potential human errors.

For example, visualization techniques, such as graphs, charts, and reports, present the abstracted security data in a clear and accessible manner. This offers development teams an overview of vulnerabilities, risk scores, historical trends, and forecasting analysis, facilitating informed decisions and effective prioritization of security improvements.

In some embodiments, the abstraction process enhances the efficiency of the security evaluation, enabling development teams to focus on core tasks rather than tedious security management. It provides a unified and standardized view of security data, facilitating effective risk assessment and proactive identification and resolution of vulnerabilities.

Furthermore, the system's abstraction process improves collaboration between development and security teams, promoting effective communication and coordination in addressing security concerns.

In some embodiments, the system leverages historical data and forecasting analysis to predict potential security risks and trends. It applies machine learning models or statistical methods to identify patterns in past security data and predict future vulnerability likelihoods or security issues. This proactive approach allows development teams to mitigate potential vulnerabilities ahead of time, improving overall security and risk management.

In some embodiments, the automation capabilities of the system reduce manual effort and minimize human error, streamlining the security management workflow and saving valuable time and resources.

The system's integration with existing development tools and processes promotes collaboration among teams and reduces complexity. Its role-based access system ensures appropriate permissions and access levels, strengthening security measures.

In some embodiments, comprehensive security reports generated by the system provide an accurate and clear picture of the microservices' security posture. These reports summarize identified vulnerabilities across different layers, allowing teams to prioritize and address security improvements efficiently. The invention's flexibility and scalability allow for modifications and alternatives within the scope and spirit of the embodiments, reinforcing its utility in enhancing microservice security.

### BRIEF DESCRIPTION OF THE DRAWINGS/FIGURES

FIG. 1 is an illustration of an example operating environment that includes a scalable reporting system for security analysis, according to some embodiments.

FIG. 2 is an illustration of a scalable reporting system for security analysis, according to some embodiments.

FIG. 3 is an illustration of a scalable reporting system for security analysis, according to some embodiments.

FIG. 4 is a flow diagram of a method for security analysis, according to some embodiments.

FIG. 5 is a block diagram of example components of a device, according to some embodiments of the present disclosure.

### DETAILED DESCRIPTION OF THE INVENTION

The unified and automated system for managing and evaluating the security posture of microservices addresses the limitations of traditional approaches through a comprehensive approach. The system employs an abstraction process to transform and standardize security data from various Application Security tools. This abstraction allows for a higher-level view of the security posture of microservices, simplifying the complexity of managing and evaluating security across diverse components and programming languages.

The abstraction process involves extracting and consolidating security-related data from multiple Application Security tools. This data is then integrated into a unified and standardized format within a centralized platform. By abstracting the security data, the system provides a comprehensive understanding of the security landscape and eliminates the need to manually navigate through various tools and datasets.

The transformed and standardized security data supports automation and integration with existing development tools and processes. It allows for efficient data collection, analysis, and reporting, reducing reliance on manual efforts and minimizing the potential for human error.

The system employs visualization techniques to present the abstracted security data in a clear and accessible manner. Visualizations, graphs, charts, and reports provide an overview of vulnerabilities, risk scores, historical trends, and forecasting analysis. This enables development teams to make informed decisions and prioritize security improvements effectively.

The abstraction process enhances the efficiency of the security evaluation process, allowing development teams to focus on core tasks rather than tedious security management. By providing a unified and standardized view of security data, the system facilitates effective risk assessment and enables the proactive identification and resolution of vulnerabilities.

Furthermore, the system's abstraction process improves collaboration between development and security teams. It presents a common understanding of the security posture, promoting effective communication and coordination in addressing security concerns.

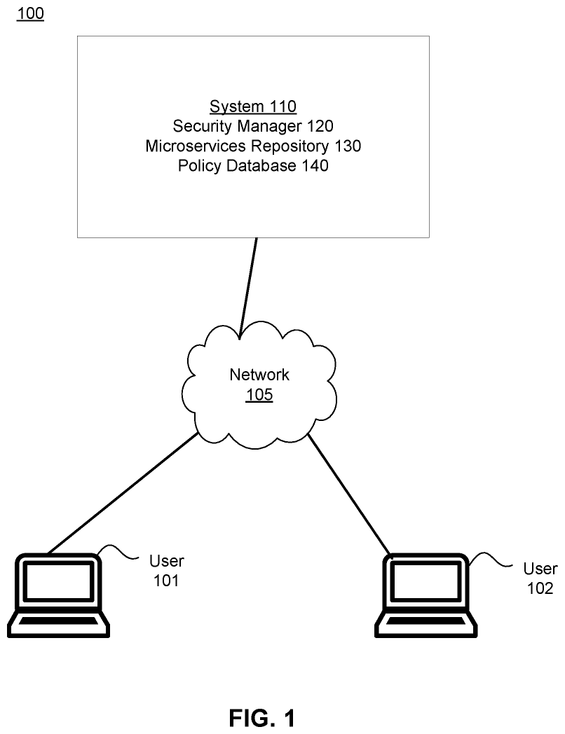

FIG. 1 illustrates an environment 100 for system 110 directed to managing the security posture of microservices through various layers of Application Security. The environment 100 can include System 110, which can provide users (e.g., 101 and 102 via network 105) with this understanding of the security posture. System 110, which can comprise one or more modules, such as Security Manager 120, Microservices Repository 130, and Policy Database 150.

Security Manager 120 serves as the centralized unit for aggregating, managing, and analyzing security-related data. In an embodiment, this element has capabilities to interact with Application Security utilities like Anchore, SonarQube, and Dependency Tool. It can also be enriched by Development cluster tools such as Jenkins, BitBucket, and Artifactory. This allows Security Manager 110 to oversee all obligatory and optional layers of security, including base image analysis, source code analysis, third-party dependencies analysis, and optionally, API security.

Microservices Repository 130 is responsible for storing metadata about all deployed microservices, including container orchestration details and network configurations. In an embodiment, this repository is actively monitored by Security Manager 110 for any changes, ensuring that the foundation of the microservices remains secure.

Policy Database 140 contains predefined and dynamically generated security policies that can be applied to microservices. These policies can be based on the analysis conducted at various security layers and could be written in languages like Open Policy Agent Rego. In a non-limiting example, Security Manager 120 uses these policies to enforce security measures on the microservices managed in Microservices Repository 130.

According to some embodiments, Security Manager 120 is configured to aggregate and analyze data across multiple layers of security. Specifically, Security Manager 120 can incorporate findings from Layer 1, which scans base images for vulnerabilities using tools like Anchore. Data from Layer 2, responsible for source code analysis through tools like SonarQube, is also integrated. Additionally, Layer 3's focus on third-party dependencies analysis, carried out by tools such as Dependency Tool, is included. Each of these layers can be further enriched by output from Development cluster tools like Jenkins, BitBucket, and Artifactory, providing an detailed security landscape.

Microservices Repository 130 maintains metadata about microservices that are foundational to the layers of security. For example, details about container images, scrutinized in Layer 1, and source code, evaluated in Layer 2, are stored. Security Manager 120 actively monitors this repository to correlate changes in these elements with its multilayered security analysis. If changes are detected, Security Manager 120 leverages Policy Database 140 to select and enforce the relevant security policies based on the cumulative security data.

Policy Database 140 houses security policies that align with the principles of each obligatory and optional security layer. These policies may specify, for instance, acceptable vulnerability levels in base images as defined in Layer 1, or required security protocols for third-party dependencies as in Layer 3. Security Manager 120 relies on these policies, written in languages like Open Policy Agent Rego, to make informed decisions about security enforcement in the microservices stored in Microservices Repository 130. This ensures that security measures are both comprehensive and targeted, addressing potential risks effectively across all layers.

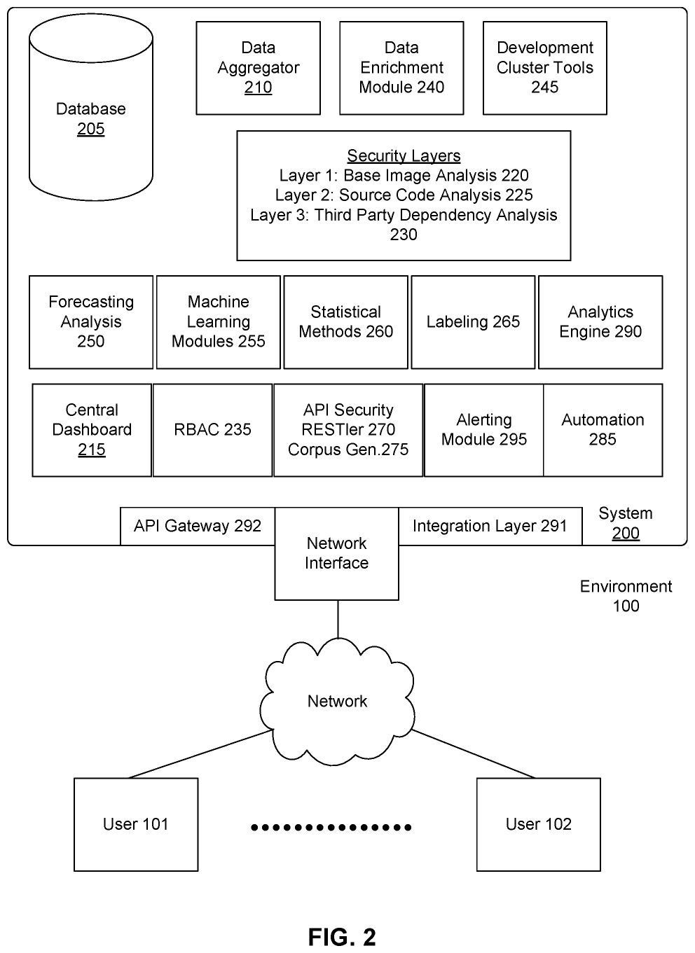

FIG. 2 depicts centralized system 200, which can be an embodiment of system 100, to manage the security posture of microservices effectively. According to some embodiments, system 200 can include Database Server 205, Data Aggregator Module 210, User Interface 215, Base Image Analysis 220, Source Code Analysis 225, Third-party Dependencies Analysis 230, Role-Based Access Control 235, Data Enrichment Module 240, Development Cluster Tools 245, Forecasting Analysis 250, machine learning models 255, statistical methods 260, Security Score Labeling 265, RESTler 270, Corpus Generation Tool 275, Automation and Efficiency Module 285, API Gateway 292, Analytics Engine 290, and Alerting Module 295. Each of these elements serves a specific function within the centralized system for managing the security posture of microservices.

In an embodiment, the centralized system, known as system 200, aims to manage and analyze data generated by Application Security utilities, including but not limited to, vulnerability scanners, code analyzers, and third-party dependency checkers. The system employs a multi-layered approach to security in a microservices environment, making it cohesive and efficient. In some embodiments, it can include three obligatory layers and one optional layer for comprehensive security.

Database Server 205 serves as the central repository for all security-related data. It supports both SQL and NoSQL databases. Its design allows for horizontal scalability to handle increasing amounts of data and to provide high availability. In a non-limiting example, a MongoDB NoSQL database is used to store unstructured data, while a PostgreSQL SQL database handles structured data, ensuring efficient data storage and retrieval.

Data Aggregator Module 210 is configured to collect data from various Application Security tools 210 like vulnerability scanners, source code analyzers, and third-party dependency checkers. It can employ a plug-and-play architecture, allowing it to integrate with new security tools easily. It normalizes the data to a common format and performs initial filtering before sending the aggregated data to the User Interface 215 through secure APIs, employing TLS encryption for data transmission.

User Interface 215 offers real-time monitoring capabilities. It displays data in various formats such as graphs, charts, and tables for easier comprehension. Security personnel can customize the dashboard to focus on metrics that are most relevant to the organization's needs. The Central Dashboard can be built using technologies like React for the frontend and Node.js for the backend, and can integrate with DevOps tools through APIs for extended functionalities.

Base Image Analysis 220 represents the first obligatory layer of security. It scans container images for vulnerabilities and misconfigurations. In a non-limiting example, Anchore is used to scan Docker and OCI images. Anchore integrates with Development Cluster Tools 245 such as Jenkins and Artifactory to provide real-time scanning as images are built, helping to stop insecure images from being deployed.

Source Code Analysis 225, the second obligatory layer, can be aimed at scanning the source code of microservices. SonarQube can be primarily used for this, which integrates with Development Cluster Tools like BitBucket. The tool performs static code analysis to identify vulnerabilities, coding errors, and improper programming practices. It supports multiple programming languages, including Java, Python, and C++.

Third-party Dependencies Analysis 230, the third obligatory layer, focuses on analyzing third-party libraries and components. Tools such as Dependency Tool are used here, which also integrate with Development Cluster Tools 245 like Jenkins. The tool checks for vulnerabilities in the dependencies against known vulnerability databases like NVD and Snyk and provides automated alerts.

Role-Based Access Control 235 ensures that only authorized personnel have access to specific Application Security tools. It supports both predefined roles like ‘Admin,’ ‘Developer,’ and ‘Auditor,’ as well as customizable roles defined by organizational policies. Access control lists (ACLs) and token-based authentication methods are employed for secure access.

Data Enrichment Module 240 works in conjunction with Development Cluster Tools 245 like Jenkins, Artifactory, and BitBucket. It fetches metadata about code builds, repository status, and more to enrich the security data, facilitating a more in-depth analysis.

Forecasting Analysis 250 uses machine learning models 255 like Random Forests and Neural Networks, along with statistical methods 260 like regression analysis, to predict future security risks. It employs algorithms to analyze historical data from Database Server 205 and outputs a risk score that can be integrated into the User Interface 215.

Security Score Labeling 265 assigns scores to each microservice based on its current security status. These scores are presented as color codes, RED, YELLOW, and GREEN, aiding in quick risk assessment.

Automation and Efficiency Module 285 streamlines data collection processes. It employs cron jobs and event-driven architectures to collect data at predefined intervals or based on specific triggers. It reduces the scope of human error and improves the system's overall efficiency.

API Gateway 292 enables communication between the various modules of the system. It uses technologies like GraphQL or RESTful APIs for data interchange and optimizes resource utilization by load balancing and caching responses.

The optional Layer 4 focuses on API Security. RESTler 270 and Corpus Generation Tool 275 are used here. RESTler performs stateful REST API fuzzing, generating test cases based on OpenAPI specifications. Corpus Generation Tool 275 employs AFL++ to generate initial test cases and a Custom Dynamic Instrumentation Tool (DIT) to test non-typical execution branches in target applications, uncovering additional security issues.

System 200 provides a multi-layered approach to managing the security posture of microservices by incorporating both obligatory and optional layers of Application Security, enriched by Development Cluster Tools. This architecture enables comprehensive risk assessment and facilitates collaboration between development and security teams. In an embodiment, Analytics Engine 290 serves as the system's computational core for data analysis. It employs machine learning algorithms like K-Means clustering and Principal Component Analysis to identify data patterns and anomalies. The engine can be built on scalable computing resources, including GPUs for computationally intensive tasks. Data normalization and feature extraction methods are applied before analysis, and the results are stored back in the Database Server 205 for further querying and reporting.

Alerting Module 295 can be configured to provide real-time notifications to administrators and security teams. It relies on the data processed by Analytics Engine 290 and Forecasting Analysis 250 to trigger alerts. Various notification channels are supported, including but not limited to, email, SMS, and Slack. The module employs rate-limiting to avoid alert fatigue and offers configurable severity levels for notifications. Alerting Module 295 auto-generates detailed reports based on the data analyzed by Analytics Engine 290 and other modules. These reports can be customized according to time ranges, data types, and key metrics. Scheduled report generation can be also supported, and the reports can be exported in formats such as PDF, CSV, or Excel.

A System Health Monitor (not shown) can be provided to continuously oversee the operational status of each component within system 200. It can be provided to utilize performance metrics to gauge component health. If any component is underperforming or offline, it can be flagged, and notifications are triggered through Alerting Module 295. Automated scripts can be configured to restart failed components.

User Interface 215 can be configured to provide users with a mechanism to execute specific SQL or NoSQL queries on the data stored in Database Server 205. This feature enables deeper data analysis and can support complex query structures involving joins, filters, and aggregations. The interface can be built using technologies like GraphQL and offers secure access control to prevent unauthorized data access.

Integration Layer 291 allows system 200 to interface with external systems via secure APIs, employing protocols like OAuth 2.0 for secure access. This makes the system extensible and enables it to pull in data or push data out to third-party applications like external vulnerability databases, DevOps tools, or other analytics platforms.

User Interface 215 serves as a web-based dashboard for system management and monitoring. It employs HTML, CSS, and JavaScript frameworks like Angular for a responsive design. Key metrics and security scores from Security Score Labeling 265 are displayed. Additional widgets can be added for custom KPIs relevant to the organization's security posture.

A Cache Layer (not shown) can be provided to store frequently accessed data in-memory using technologies like Redis or Memcached to reduce database load and improve system response times. This can be particularly useful for data that is read-heavy and not updated frequently, like historical vulnerability data or pre-computed analytics results.

A Configuration Management module provided by Dashboard 215 gives administrators the capability to set and modify configurations for various components and modules within system 200. It supports both file-based and UI-based configuration methods and allows for versioning of configuration changes for rollback purposes.

System 200 operates as a comprehensive solution for managing the security posture of microservices, overcoming the limitations of prior technologies by integrating multiple functionalities into a unified, automated framework. It uses a multi-layered architecture that includes obligatory and optional layers of Application Security and can be enriched by Development Cluster Tools. This facilitates better risk assessment and collaboration between development and security teams.

At its core, the system employs Analytics Engine 290 for data analysis. The engine uses machine learning algorithms such as K-Means clustering and Principal Component Analysis to identify patterns and anomalies in security data. Computation can be scalable and uses GPUs for intensive tasks. Data can be first normalized and features are extracted before it undergoes analysis. The results are then stored in Database Server 205 for future use.

Alerting Module 295 can send notifications through various channels like email or SMS to administrators or security teams based on real-time analytics and forecasting from Forecasting Analysis 250. System Health Monitor oversees the operational status of each module within system 200, flagging any underperformance for immediate action. User Interface 215 provides the ability for users to execute specific queries on stored data for deeper insight.

Alerting Module 295 generates reports based on this data, which can be customized and scheduled as needed. User Interface 215 can be web-based and offers a dashboard for system management, displaying metrics and security scores. The Cache Layer can store frequently accessed data for improved system performance, while User Interface 215 enables administrators to set system configurations.

System 200 automates the collection and deduplication of data from various Application Security tools, thus reducing redundancy and human error, a shortcoming in previous technologies. It also uses forecasting analysis to predict potential risks, enabling proactive security measures, an aspect not efficiently utilized in prior systems. The role-based access system facilitates better management and collaboration among teams.

In operational terms, system 200 works through a series of steps beginning with the monitoring of release updates for microservices. Projects are created for each microservice and its corresponding release version. Data collection can be initiated, retrieving security data from various tools connected to each microservice. This data can then be analyzed for deduplication and impact fine-tuning, after which forecasting analysis can be run. Security labels are assigned to each microservice based on the analysis, and a comprehensive Security Release report can be generated and distributed to one or more users.

The invention significantly improves upon previous technologies by automating the entire process of security management for microservices. This includes automated data collection and deduplication, advanced analytics using machine learning, real-time alerting, and comprehensive reporting. The integrated nature of these functionalities reduces the risk of human error, improves the accuracy of security data, and enables proactive security management by leveraging forecasting analysis. The system can be configured to provide extensibility and integration with external tools and systems, thereby enhancing its utility and adaptability. Overall, system 200 presents a unified, automated, and comprehensive approach to microservice security management, offering significant benefits such as improved risk management, increased security, reduced human error, and enhanced utilization of historical data and forecasting analysis.

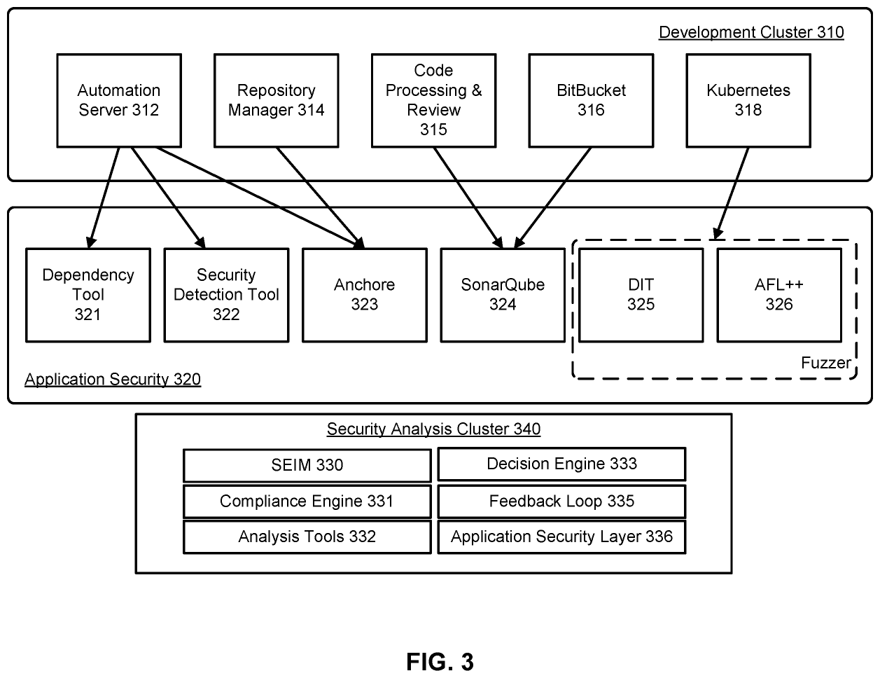

FIG. 3 illustrates System 300 for managing the development and application security of software processes. System 300 provides a unified solution for security assessment in a microservices environment. According to some embodiments, System 300 provides a comprehensive system that addresses various aspects of security comprehensively, enhancing the overall security landscape of the software development process. System 300 can include Development Cluster 310 and Application Security Layer 320. Different embodiments may encompass variations, adaptations, or alternatives of the components and their interconnections within System 300, providing a flexible and scalable solution for diverse microservices architectures.

System 300 comprises Development Cluster 310, which can include one or more components configured to manage various aspects of software development. System 300 can also include Application Security Layer 320, which includes one or more components on the security of the applications and connections between different elements of the development process.

Development Cluster 310 can include several distinct elements that can be used in the software development process, including Automation Server 312, Repository Manager 314, Code Processing/Review Layer Tool 315, BitBucket 316, and Kubernetes 318. Automation Server 312 can be utilized for automating parts of the development process. Repository Manager 314 can be another component in the cluster, functioning as a repository manager that supports the software package management. In a non-limiting example, Repository Manager can include Artifactory, or the like. Code Processing/Review Layer 315 can be a specialized tool configured to fit within the specific development environment of System 300. BitBucket 316 serves as a web-based version control repository hosting service that integrates with other parts of the Development Cluster 310. Kubernetes 318, another essential part of the Development Cluster 310, acts as an orchestration platform, managing containers and the infrastructure.

Application Security Layer 320, as depicted in FIG. 3 of System 300, includes several components like Dependency Tool 321, Security Detection Tool 322, Anchore 323, SonarQube 324, DIT 325, and AFL++326. Dependency Tool 321 can be configured to manage software dependencies within the system and to ensure a secure connection to the development components. Security Detection Tool 322 provides security monitoring and vulnerability scanning functions within System 300. Anchore 323 can be involved in the inspection, analysis, and certification of container images, ensuring their integrity. SonarQube 324 performs continuous inspection of code quality. DIT 325 and AFL++326, both components of a fuzzer, work together to provide automated testing functionality within System 300. The fuzzer includes DIT 325, a dedicated tool for conducting specific types of testing, and AFL++326, an enhancement that supplements the testing process.

In a non-limiting example, within FIG. 3, Automation Server (e.g., Jenkins) 312 can establish connections with Dependency Tool 321, Security Detection Tool 322, and Anchore 323, enabling interaction. Repository Manager 314 can be linked to Anchore 323, creating a bridge between the repository manager and the container image security tool. Code Processing/Review Layer Tool 315 interfaces with SonarQube 324, showcasing their close collaboration in development and code quality inspection. BitBucket 316 can be also connected to SonarQube 324 to enable code inspection. Furthermore, Kubernetes 318 can be integrated with the Fuzzer, comprising DIT 325 and AFL++326, establishing connection between the orchestration platform and the testing tools. It's important to note that Dependency Tool 321, Anchore 323, and SonarQube 324 contribute valuable information to the internal database, consolidating data management within System 300.

Within Development Cluster 310, Automation Server 312 can include Jenkins or a similar element for providing an automation server that facilitates continuous integration and continuous delivery (Cl/CD) processes. Within System 300, Jenkins 312 might be utilized to automate the process of collecting, analyzing, and reporting security data. This may involve triggering scans in other Application Security tools, coordinating with other elements of the development cluster, and reporting the findings for further analysis. In some embodiments, Jenkins 312 connects with tools such as Dependency Tool 321, Anchore 323, and other Application Security utilities, orchestrating the security assessments across different layers of the microservices architecture. Repository Manager 314 can include Artifactory, or another similar platform, as a binary repository manager integrated within Development Cluster 310 in System 300. It serves as a centralized location for storing and managing binary artifacts and dependencies. In the specific context of System 300, Repository Manager 314 liaises with Anchore 323 to enable the analysis of container images used for deploying microservices. Its ability to manage third-party dependencies and ensure version control aligns with the broader objective of efficient vulnerability management within System 300.

Also within Development Cluster 310, Code Processing/Review Layer Tool 315 can be a custom development tool that may serve various development-related functions, such as version control, code review, build automation, or more specific tasks tailored to the software development process. It collaborates with SonarQube 324 in Application Security Layer 320, focusing on source code analysis to identify potential security issues, including coding errors, vulnerabilities, and improper programming practices. BitBucket 316, part of Development Cluster 310 in System 300, can be a web-based version control repository hosting service. Within the framework of the invention, BitBucket 316 performs source code management, enabling collaboration, branching, and merging. Its specific connection with SonarQube 324 facilitates the analysis of source code and the identification of vulnerabilities, ensuring adherence to secure coding practices.

Within Application Security Layer 320 of System 300, Dependency Tool 321 specializes in third-party dependencies analysis. As microservices often rely on third-party libraries and components, Dependency Tool 321 focuses on analyzing these dependencies for known security issues. By collaborating with Jenkins 312, it ensures that the dependencies are up to date and free from known vulnerabilities. It represents a key aspect of security management in microservices. Security Detection Tool 322 can be configured to enhance the evaluation of security risks associated with microservices. Security Detection Tool 322 could perform tasks such as analyzing security data from multiple sources, identifying overlaps or discrepancies in assessments, and providing a unified view of the security landscape. It can also connect with Jenkins 312, facilitating an automated approach to security analysis, reducing the likelihood of human error, and streamlining the security assessment process. Anchore 323, part of Application Security Layer 320 in System 300, addresses base image analysis. It can be configured to scan container images used for deploying microservices for known vulnerabilities, misconfigurations, or other potential risks. By collaborating with Repository Manager 314 and Jenkins 312, it ensures the foundation of the microservices is secure, thereby addressing the challenges associated with containerized deployment. SonarQube 324, another component of Application Security Layer 320, is operative in source code analysis. Working in conjunction with Code Processing/Review Layer Tool 315 and BitBucket 316, SonarQube 324 performs static code analysis to identify coding errors, vulnerabilities, or improper programming practices. Its role in System 300 aligns with the broader goal of ensuring that the source code of microservices adheres to secure coding standards.

Fuzzer/API Security Tools (e.g., RESTler, Corpus Generation Tool, DIT 325, AFL++326) can provide an optional Layer 4 in System 300, focusing on securing the API layer of microservices. RESTler, along with Corpus Generation Tool, DIT 325, and AFL++326, analyzes and tests the APIs to identify potential security and reliability issues. The integration of these tools within System 300 ensures that the exposed interfaces are secure, thereby enhancing the overall security posture of the microservices architecture.

The interconnections between these components within System 300 reflect a multi-layered and cohesive approach to security, addressing different aspects comprehensively and effectively. The collaboration between development and security tools, as outlined in FIG. 3, exemplifies a centralized system configured to aggregate, manage, and analyze security-related information, leading to a more secure and reliable software product.

In some embodiments, System 300 may be configured differently with various interconnections between Development Cluster 310 and Application Security Layer 320. One or more examples may include different configurations of Development Cluster 310, possibly incorporating other development tools or excluding some existing ones. The interconnections may also be modified to suit different architectures or requirements. Similarly, Application Security Layer 320 could be altered or expanded to include additional security features, tools, or functionalities.

The detailed representation in FIG. 3 of System 300 illustrates a comprehensive and adaptable framework for managing both development and security aspects of software processes. By including various components and allowing flexibility in the connections between them, System 300 provides an unconventional platform that can be tailored to diverse needs and specific implementations. Different configurations and adaptations can further enhance the versatility of System 300, supporting a broad range of applications and use cases in the field of software development and security.

In reference to FIG. 3, System 300 is shown, constituting a comprehensive software development environment aimed at managing and evaluating the security posture of microservices. System 300 encompasses Development Cluster 310 and Application Security Layer 320, both working cohesively to provide a unified and efficient method to assess and mitigate security vulnerabilities in microservices.

Development Cluster 310 includes several components that cater to diverse microservices developed using different programming languages, base images, and third-party components. Specifically, Jenkins 312, part of Development Cluster 310, can be configured to perform automation of collecting, analyzing, and reporting security data. In some embodiments, Jenkins 312 connects to Dependency Tool 321, Security Detection Tool 322, and Anchore 323 in Application Security Layer 320, facilitating the integration of diverse security tools. Repository Manager 314 in Development Cluster 310 is operatively connected with Anchore 323 to enable analysis of container images used for deploying microservices, a critical aspect of base image analysis. Furthermore, Code Processing/Review Layer Tool 315 in Development Cluster 310 collaborates with SonarQube 324, focusing on source code analysis, whereas BitBucket 316 contributes to the scrutiny of source code, augmenting the security assessments. Kubernetes 318, forming part of Development Cluster 310, provides orchestration of containerized microservices and offers scalability, with connections to the optional fuzzer comprised of DIT 325 and AFL++326.

Within System 300, Application Security Layer 320 further enriches the security landscape by providing a multi-layered approach to address the challenges and vulnerabilities in a microservices environment. Dependency Tool 321, one of the components of Application Security Layer 320, specializes in third-party dependencies analysis. Along with Jenkins 312, it forms a layer that ensures that dependencies are analyzed for known security issues. Security Detection Tool 322, also a constituent of Application Security Layer 320, might be utilized in some embodiments to enhance the evaluation of security risks associated with diverse microservices, providing a clear view of the security posture. Anchore 323, part of Application Security Layer 320, collaborates with Repository Manager 314 and Jenkins 312 for base image analysis. This aspect focuses on scanning base images, providing insights into potential risks and vulnerabilities, which may be tailored or adjusted according to the specific needs of the microservices environment. SonarQube 324, another component of Application Security Layer 320, is operative in source code analysis, working with Code Processing/Review Layer Tool 315 and BitBucket 316 to identify coding errors and incorrect programming practices. Its connection with the development tools helps in static code analysis and contributes to efficient vulnerability management.

In conjunction with AFL++326, DIT 325 forms part of an optional fuzzer that emphasizes API Security within System 300. This fuzzing tool, linked to Kubernetes 328, tests cloud services through REST APIs, uncovering vulnerabilities and misconfigurations. AFL++326, a widely used fuzzer, and DIT 325 enable RESTler to reach non-typical execution branches, enhancing the security assessment process.

In some embodiments, System 300 can be configured with various interconnections as shown. In a non-limiting example, Jenkins 312 can be connected with Dependency Tool 321, Security Detection Tool 322, and Anchore 323, to facilitate coordination. Repository Manager 314 can be connected to Anchore 323, serving as a critical conduit between the repository manager and the container image security tool. Code Processing/Review Layer Tool 315 can interface with SonarQube 324, to facilitate development and code quality inspection. BitBucket 316 can interface with SonarQube 324. In addition, Kubernetes 318 can be interconnected with the Fuzzer, encompassing DIT 325 and AFL++326, to provide functionality between the orchestration platform and the testing tools. The modules collectively enable efficient data management and analysis within the framework.

In some embodiments, Dependency Tool 321, Security Detection Tool 322, and Anchore 323 can be configured to output to a database, to perform aggregating, managing, and analyzing data generated by Application Security utilities. These connections enable identifying and mitigating security vulnerabilities.

In some embodiments, system 300 can further include Security Analysis Cluster 340. Security Analysis Cluster 340 can include Corporate Security Information and Event Management (SIEM) 330 as a centralized hub for aggregating and correlating logs and events from various sources, including the components of Development Cluster 310 and Application Security Layer 320. By providing real-time analysis of security alerts and facilitating historical data analysis, Corporate SIEM 330 enhances the overall security posture of the microservices, ensuring timely detection of suspicious activities or potential breaches. Security Analysis Cluster 340 can further include Compliance Engine 331, configured to manage and ensure that that all activities within the system adhere to relevant regulatory and internal compliance requirements. Whether it's GDPR, HIPAA, or other industry-specific regulations, Compliance Engine 331 continually checks the configurations, coding practices, and overall design of the microservices against predefined compliance standards, reducing legal risks and reinforcing trust within the ecosystem.

In some embodiments, Security Analysis Cluster 340 can also include Analysis Tools 332 comprising various sub-tools configured to manage specific security analytics tasks. These may include risk assessment, threat modeling, incident response analysis, and more. In the context of System 300, Analysis Tools 332 collaborate with Corporate SIEM 330 to facilitate in-depth analysis of the security data, enabling the organization to identify patterns, trends, and potential vulnerabilities that might not be evident from individual data points. Security Analysis Cluster 340 can also include Decision Engine 333. By leveraging machine learning algorithms or other advanced analytics methods, it can take the aggregated data from Corporate SIEM 330, Compliance Engine 331, and Analysis Tools 332 to make informed decisions. This might include automated responses to detected threats, prioritization of remediation tasks, or recommendations for enhancing security controls. Security Analysis Cluster 340 can also include Feedback Loop to Development Cluster 335, a connector providing a continuous communication channel between Security Analysis Cluster 340 and Development Cluster 310. It ensures that insights, findings, and recommendations derived from the security analysis are fed back into the development cycle. Whether it's updating coding practices, patching known vulnerabilities, or revising configurations, this feedback loop fosters an adaptive, responsive, and resilient microservices environment. Security Analysis Cluster 340 can also include Feedback to Application Security Layer 336, configured to ensure that insights obtained from the security analysis are used to update and refine the security controls, processes, and configurations within Application Security Layer 320. This continuous improvement process aligns with the principle of security being an ongoing endeavor rather than a one-time task. Further, as previously mentioned, the optional Layer 4 in System 300 focuses on securing the API layer of microservices. The tools within this layer (e.g., RESTler, Corpus Generation Tool, DIT 325, AFL++326) might be tailored to the specific needs of the organization, providing additional flexibility in securing the interfaces and interactions within the microservices architecture.

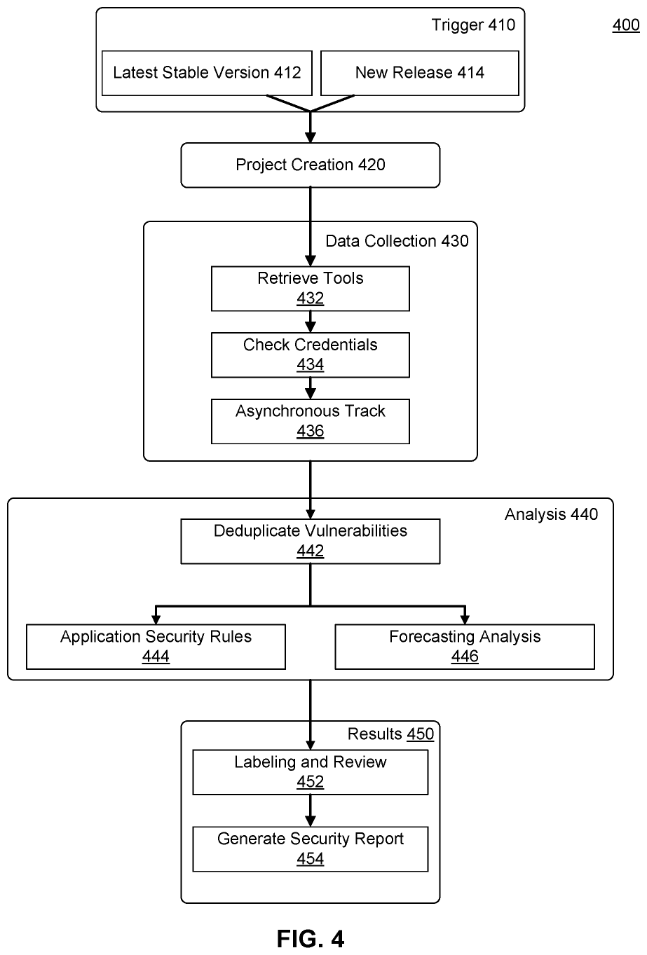

FIG. 4 depicts Process 400, provided as an automated workflow for managing and evaluating the security posture of microservices throughout their development cycle. Process 400 is a workflow configured to manage and evaluate the security posture of microservices in a software development environment. It comprises five distinct yet interlinked stages—Trigger 410, Project Creation 420, Data Collection 430, Analysis 440, and Output 450— which function in an orchestrated manner to automate and enhance various facets of software development and application security.

In the Trigger 410 stage, two principal components come into play: Latest Stable Version 412 and New Release 414. The Latest Stable Version 412 might include an API request made to specific source code repositories like GitHub. This request could be constructed as RESTful API calls that specifically look to capture data elements, such as the version numbers, date of last modification, and dependencies. New Release 414, by contrast, might employ web scraping methodologies to periodically scan the Confluence Releases page. This can be set up to happen at defined intervals—every 24 hours, for example—capturing data like release notes, version identifiers, and time stamps, which then populate an internal database, potentially developed in relational database management systems like My SQL or PostgreSQL.

Upon completion of the Trigger stage, the workflow proceeds to Project Creation 420. This phase may involve the instantiation of new Project objects, for example, managed by object-oriented programming languages such as Java or Python. These objects serve as a repository for metadata, such as version numbers and microservice names, and are configured to integrate with Automation Server 312 from FIG. 3. They can also be provided to store statuses and results from subsequent stages, effectively centralizing data and facilitating real-time tracking and management.

Process 400 continues with Data Collection 430 phase. This stage may involve a range of sub-tasks. For example, Retrieve Tools 432 could initiate SQL queries targeted at a Connections table configured to store mappings between specific microservices and connected Application Security tools. Check Credentials 434, in some embodiments, might utilize protocols like LDAP or OAuth2 to validate that access can be restricted to authorized users. Asynchronous Track 436 can be configured to implement an asynchronous programming model, perhaps using frameworks like Node.js, to manage parallel data collection tasks. This collected data may be serialized into JSON or XML formats before being stored in a NoSQL database such as MongoDB.

Analysis 440 then follows, providing several computational and analytical functionalities. Deduplicate Vulnerabilities 442 might employ hash functions to eliminate redundancy in vulnerability records. Application Security Rules 444 could use rule engines to apply predefined security conditions that adjust the impact of vulnerabilities. Forecasting Analysis 446 may employ machine learning algorithms to statistically model future security risks based on historical data.

At operation 450, Labeling and Review 452 and Generate Security Report 454 processes are performed. Labeling and Review 452 can utilize algorithms to assign a security score to each microservice. In a non-limiting example, Labeling and Review 452 can utilize Common Vulnerability Scoring System (CVSS) to perform these functions. Generate Security Report 454 can be operative to compile these scores and other key metrics into a detailed document, which could be constructed using specialized reporting software capable of incorporating data visualizations.

Therefore, Process workflow 400 provides a framework for handling a lifecycle of microservice security assessment. It leverages layer analysis, data aggregation, and security protocols to offer an automated solution for security management. By performing analysis based on the three obligatory layers, the process ensures consistent security evaluations. Through its implementation of System 300, it facilitates an integrated approach, ensuring that the system remains up-to-date and adaptable to emerging challenges.

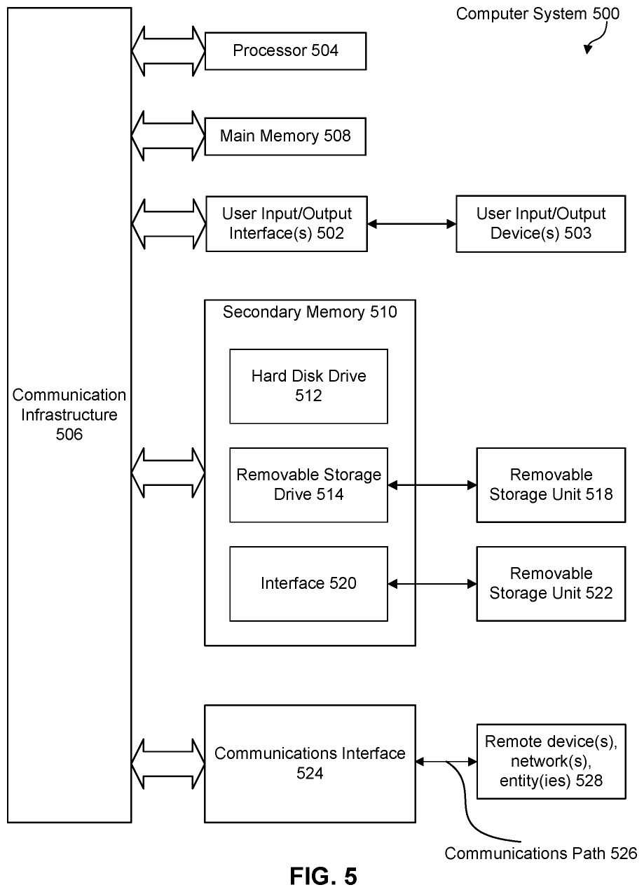

FIG. 5 is a block diagram of example components of device 500. One or more computer systems 500 may be used, for example, to implement any of the embodiments discussed herein, as well as combinations and sub-combinations thereof. Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more processors 504 may be a graphics processing unit (GPU). In an embodiment, a GPU may be a processor that can be a specialized electronic circuit configured to process mathematically intensive applications. The GPU may have a parallel structure that can be efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514.

Removable storage drive 514 may interact with a removable storage unit 518. Removable storage unit 518 may include a computer-usable or readable storage device having stored thereon computer software (control logic) and/or data. Removable storage unit 518 may be program cartridge and cartridge interface (such as that found in video game devices), a removable memory chip (such as an EPROM or PROM) and associated socket, a memory stick and USB port, a memory card and associated memory card slot, and/or any other removable storage unit and associated interface. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smartphone, smartwatch or other wearables, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A centralized system for automated management and evaluation of microservice security in a software development environment, comprising:
a data aggregation module operatively coupled to receive security data from multiple Application Security tools, wherein the received security data includes base image analysis, source code analysis, third-party dependencies analysis, and API security analysis, and transform the collected data into a standardized format;
a deduplication module operatively coupled to the data aggregation module, configured to identify overlapping vulnerability records based on vulnerability names, severity levels, and sources, merge the identified records into a single vulnerability record, and update the internal database with the merged record;
a historical data analysis module operatively coupled to the data aggregation module, configured to analyze the collected historical security data, apply machine learning models or statistical methods to predict potential security risks and trends, and generate risk scores and trend reports;
an integration module operatively coupled to existing development tools, configured to establish connections, retrieve relevant information, and enrich the security data with contextual insights;
a role-based access system module configured to control access to the security data and tools based on predefined user roles and responsibilities, and grant permissions and access levels accordingly.

2. The system of claim 1, wherein the data aggregation module transforms the received security data into a standardized format by extracting key information, such as vulnerability names, components, severity levels, sources, and descriptions.

3. The system of claim 1, wherein the deduplication module updates the internal database by merging the identified overlapping vulnerability records into a single vulnerability record, reducing redundancy and ensuring an accurate representation of security risks.

4. The system of claim 1, wherein the historical data analysis module utilizes the collected historical security data to generate risk scores, trend reports, and predictive models for potential security risks and trends, providing insights for risk assessment and mitigation planning.

5. The system of claim 1, wherein the integration module establishes connections with existing development tools, retrieves relevant information, such as build and release data, and enriches the security data by incorporating contextual information, thereby enhancing the accuracy and completeness of the security analysis.

6. The system of claim 1, wherein the role-based access system module controls access to the security data and tools by granting permissions and access levels to users based on predefined user roles and responsibilities, ensuring appropriate data protection and restricted access to sensitive information.

7. The system of claim 1, further comprising a visualization module operatively coupled to the data aggregation module and historical data analysis module, configured to generate visual representations, including graphs, charts, and reports, summarizing the microservice security history, vulnerabilities, risk scores, and forecasted trends, providing one or more users with a view of the security landscape for risk management.

8. A method for automated management and evaluation of microservice security in a software development environment, comprising:
receiving security data from multiple Application Security tools, including base image analysis, source code analysis, third-party dependencies analysis, and API security analysis;
transforming the received security data into a standardized format;
identifying overlapping vulnerability records based on vulnerability names, severity levels, and sources;
merging the identified overlapping vulnerability records into a single vulnerability record;
updating an internal database with the merged vulnerability record;
analyzing collected historical security data and applying machine learning models or statistical methods to predict potential security risks and trends;
generating visual representations summarizing microservice security history, vulnerabilities, risk scores, and forecasted trends.

9. The method of claim 8, further comprising extracting key information from the received security data, including vulnerability names, components, severity levels, sources, and descriptions, during the transformation into a standardized format.

10. The method of claim 8, further comprising utilizing the collected historical security data to generate risk scores, trend reports, and predictive models for potential security risks and trends.

11. The method of claim 8, further comprising establishing connections with existing development tools, retrieving relevant information, and enriching the security data by incorporating contextual insights.

12. The method of claim 8, further comprising controlling access to the security data and tools based on predefined user roles and responsibilities.

13. The method of claim 8, further comprising generating visual representations, including graphs, charts, and reports, summarizing the microservice security history, vulnerabilities, risk scores, and forecasted trends.

14. The method of claim 8, further comprising providing the generated visual representations, risk scores, and trend reports to one or more users for risk management.

15. A computer-readable medium comprising instructions that, when executed by a processor, perform the steps of:
receiving security data from multiple Application Security tools, including base image analysis, source code analysis, third-party dependencies analysis, and API security analysis;
transforming the received security data into a standardized format;
identifying overlapping vulnerability records based on vulnerability names, severity levels, and sources;
merging the identified overlapping vulnerability records into a single vulnerability record;
updating an internal database with the merged vulnerability record;
analyzing collected historical security data and applying machine learning models or statistical methods to predict potential security risks and trends;
generating visual representations summarizing microservice security history, vulnerabilities, risk scores, and forecasted trends.

16. The computer-readable medium of claim 16, further comprising instructions for extracting key information from the received security data, including vulnerability names, components, severity levels, sources, and descriptions, during the transformation into a standardized format.

17. The computer-readable medium of claim 16, further comprising instructions for utilizing the collected historical security data to generate risk scores, trend reports, and predictive models for potential security risks and trends.

18. The computer-readable medium of claim 16, further comprising instructions for establishing connections with existing development tools, retrieving relevant information, and enriching the security data by incorporating contextual insights.

19. The computer-readable medium of claim 16, further comprising instructions for controlling access to the security data and tools based on predefined user roles and responsibilities.

20. The computer-readable medium of claim 16, further comprising instructions for generating visual representations, including graphs, charts, and reports, summarizing the microservice security history, vulnerabilities, risk scores, and forecasted trends.
